(19) United States
(12) Patent Application Publication
(10) Pub. No.: US 2009/0070500 A1
(43) Pub. Date: Mar. 12, 2009

(54) Sharing of data between devices

(76) Inventors: Mikko Suomela, Vesilahti (FI); Vesa Saario, Ylojarvi (FI); Jouni Rapakko, Kylmakoski (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/578,686

(22) PCT Filed: Apr. 7, 2005
(86) PCT No.: PCT/FI2005/050113

§ 371 Date: Apr. 14, 2008

(30) Foreign Application Priority Data
Apr. 13, 2004 (FI) 20045129

(51) Int. Cl. G06F 13/12

(52) U.S. Cl. 710/62

(57) ABSTRACT

The invention relates to the sharing of data between a first and a second device. A data transmission connection is set up between the devices to adapt the devices and to share data between the devices. The second device comprises an adapter program which adapts the first device to the second device on the basis of the setting data of the first device. The setting data of the first device are arranged in the first device, wherein the setting data are transmitted to the second device to implement the adaptation.

The present invention relates to a method for sharing data between one and at least another device as described in the preamble of claim 1. The invention also relates to a data processor according to the preamble of claim 4, as well as to a data processor according to the preamble of claim 5. Furthermore, the invention relates to a data processing system according to the preamble of claim 8 as well as computer software products according to the preambles of claims 10 and 11.

Data transmission between two devices is known from various contexts. Data transmissions between computers as well as data transmissions between portable computers and other portable devices, such as mobile phones and personal digital assistants (PDA) are common operations in modern data processing. In addition to device-specific data transmissions, a need has also arisen to share information between devices of different types. And this need is increased, the more sophisticated the devices become. For example, a portable device can be connected to a computer via a USB cable, an infrared connection or a wireless Bluetooth connection. Furthermore, the computer requires a customized program, a so-called “adapter program”, for importing data in the portable device, for synchronizing the data of the portable device with the data of the computer, or for configuring the portable device. By means of the adapter program, it is possible to share data between the computer and the portable device as well as to install software in the portable device.

The adapter program is stored in the computer and is suitable for several different models of portable devices by the same manufacturer. When new models are introduced on the market, the adapter program must be updated or a new version of it must be installed. The adapter program comprises device-specific information about the device models supported by it at the time. When the device is coupled to a computer, the adapter program identifies the device and retrieves the properties related to it from its own data storage. If the properties of the device in question are not found in the data storage, the device may be newer than the adapter program version in question.

The updating of a single adapter program does not necessarily present a problem for a private user, although it requires extra work. However, it is obvious that the more adapter programs there are to be updated, the more laborious the updating becomes. Such a situation may come up, for example, in the business world, where several employees may have different models of portable devices.

The consumer is normally provided with the adapter program of the portable device in connection with the purchase of the portable device. Furthermore, adapter programs are provided to be downloaded via the Internet, for which reason the adapter programs are easily accessible to a computer. With time, as more and more device models are launched on the market, the number of adapter programs increases as well, and the larger the supply of adapter programs becomes. This, in turn, may make it more difficult for the user to select the correct adapter program.

It may well be found that the present way of connecting a terminal to a computer is only down-compatible (i.e., backward compatible). This means that the adapter program is compatible with earlier device models but not future ones. In other words, the prior art seems to lack an adapter program which is also suitable for future device models (up-compatibility, or forward compatibility), which adapter program would be device independent). It is an aim of the present invention to provide a solution for implementing the adaptation of devices and the sharing of data.

The invention relates to data processors as well as a method for adapting them to each other. The method according to the invention is primarily characterized in that the configuration data of said first device are provided in said first device.

Furthermore, the invention relates to a system which is primarily characterized in that the first device is arranged to store such configuration data which relate to said adaptation, said second device being adapted to retrieve said configuration data from said first device via a data transmission connection to implement the adaptation. The invention also relates to computer software products which can be arranged in the above-mentioned data processors.

The invention is very significant for the possibilities to use the adapter program. The arrangement according to the invention makes it possible to connect a portable device to an adapter program whose version is older than the device. From this, it can be easily seen that adapter programs of different versions are no longer needed.

The invention will be described in more detail with reference to the appended drawings intended to facilitate the understanding of the method according to the invention and not to restrict the invention.

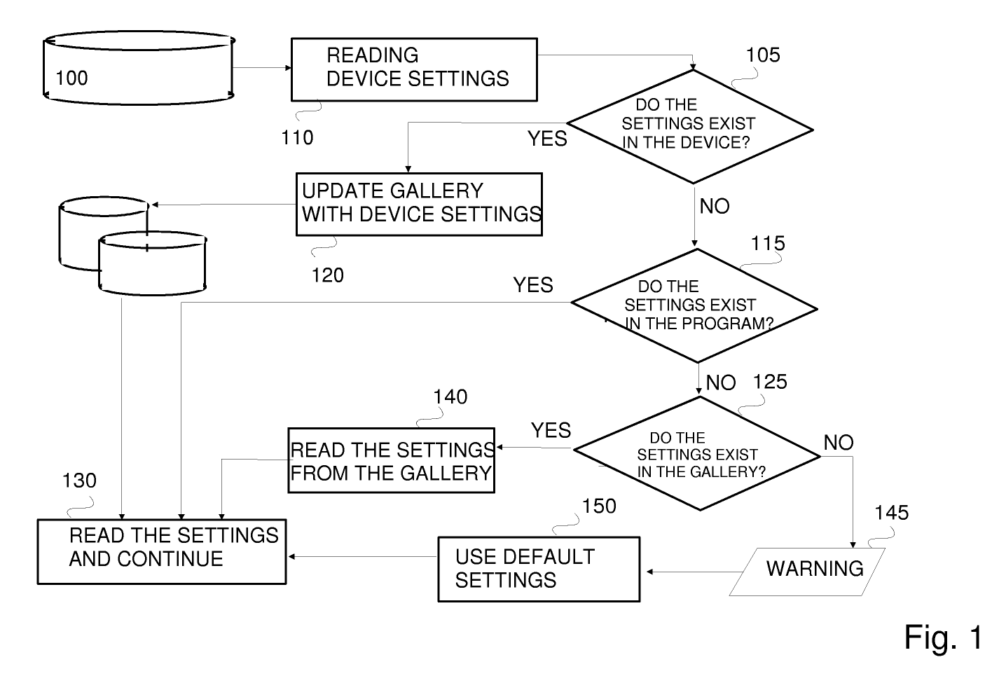

FIG. 1 shows one example of the steps according to an embodiment of the invention in a reduced block chart, and

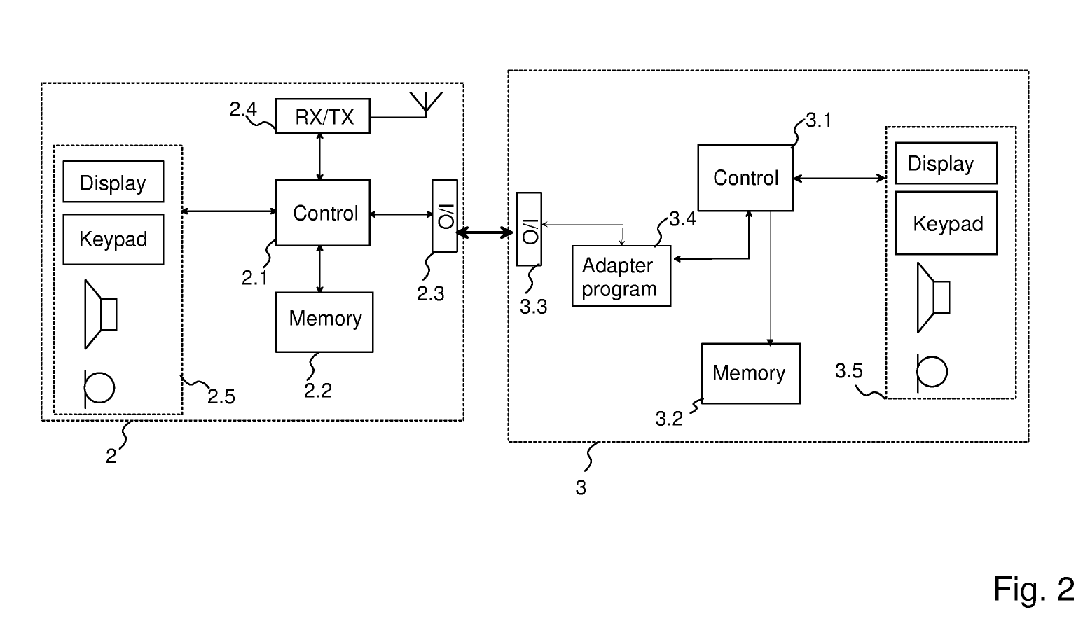

FIG. 2 shows an example of a data processing system according to the invention, comprising a first and a second data processor.

As described above, the coupling of a portable device to a computer can be implemented physically in different ways. To control the device and to import data in the applications of the device, a connection with the computer is set up, for example, by means of a USB cable, an infrared connection, a wireless Bluetooth or a wireless LAN (WLAN) connection. These methods can naturally be replaced with another solution without affecting the implementation of the method according to the invention.

After setting up the connection, the adapter program of the computer is started to make data transmission possible. For starting the adapter program, device-specific configuration data relating to the portable device are utilized. In the arrangement according to the invention, the configuration data are stored in the portable device, and the adapter program adapted in the computer is arranged to know these data. With the invention, the portable device can configure itself with the adapter program and the computer.

Thanks to the fact that the configuration data of the adapter program are, according to the invention, stored in the portable device instead of the computer, the adapter program is compatible with other devices as well. When the portable device is coupled to the computer, the configuration server reads the adapter program settings (configuration data) from the device. Because of this, the adapter program does not need to know in advance, which device is in question each time. The adapter program will automatically include the required device properties in the present device properties in the computer. If the user has several portable devices, the setting data of these can also be added in the list of supported device settings. In the portable device, the configuration settings are stored in a file which can be found, for example, in the Capability entity complying with the OBEX (Object Exchange) protocol.

<Capability>

<General>

<Manufacturer>DeviceMaker Inc.</Manufacturer>
<Model> Handy100 </Model>
<SN>123456789</SN>
<SW version=“2.0”/>

</General>
<Service>

<Name>PCSuite-Settings</Name>
<Ext>

<XNam>SuiteConf</XNam>
<XVal>File=C:\Folder\SuiteConf.xml</XVal>

</Ext>

</Service>

</Capability>

If the device specific configuration data are not found in the device in question, the adapter program can use its own data instead. If the configuration data are not found in the data of the adapter program itself, it can be assumed that the device does not support the adapter program system in question.

FIG. 1 shows an example of the method according to the invention to read the configuration data from the data processor. In the figure, the configuration server (100) starts to read the device settings (110). The configuration server comprises at least the adapter program and a device data gallery for storing various device settings. At first, an attempt is made to read (105) the device specific configuration data from the device. If the configuration data are found, the device data gallery is updated (120) with them. If the configuration data are not found in the device, their location is checked from the adapter program. The found configuration data can be read directly from the adapter program. However, if the configuration data are not found there, the existing device data gallery must be checked and read (140). If the device data gallery does not comprise the desired configuration data, a warning (145) is given and the default settings of the device in question are used for the configuration (150). When the configuration server has received the configuration data needed for the adaptation, the sharing of data can be started (130).

After the configuration has been successfully completed, the sharing of data can be started. This may include, for example, the transmission of calendar entries from the portable device into the computer, and vice versa, or the management of applications in the portable device. It is obvious that the data to be shared may also be other application data in the data processor which will not be described in more detail in this context because they are assumed to be obvious for a person skilled in the art.

The data processor 2 of FIG. 2 comprises, for example, a control block 2.1 for controlling the functions of the data processor 2. Furthermore, the data processor 2 comprises a memory 2.2 for storing data, programs, etc., a connection 2.3 for connecting a configuration server 3 to the data processor 2, possible mobile communication means 2.4, as well as a user interface 2.5. The memory 2.2 comprises, e.g., stored configuration data of the data processor 2. Furthermore, FIG. 2 shows an example of a configuration server 3. The configuration server 3 also comprises a control block 3.1 for controlling the functions of the configuration server 3, as well as a memory 3.2 for storing data and program codes. The memory 3.2 is a storage of e.g. an algorithm, i.e., in practice, program instructions for performing a computation according to the algorithm. The configuration server also comprises an adapter program 3.4 which is arranged to check the configuration data of the data processor 2 by the method according to the invention. Furthermore, the configuration server 3 comprises a connection 3.3, by means of which data can be transmitted between the data processor 2 and the configuration server 3. Via the connections 2.3, 3.3, the data processor 2 can also be supplied, for example, with the required operating voltage. The configuration server 3 may also comprise a user interface 3.5. It is obvious that, in practice, the configuration server does not need to comprise all the elements shown in the figure, but it may be arranged as simple as possible. Thus, the actual utilization of the transmitted data can take place in the actual management computer, wherein the configuration server comprises means for setting up a connection with it.

Moreover, the idea of the method according to the invention is not dependent on the way of implementation. The essence of the invention is the configuration data arranged in the data processor and their reading by the external configuration server, wherein it is obvious that there may be different ways of implementation. Therefore, it is also obvious that the present invention is not limited to the presentation above, but it is applicable within the scope of the appended claims.

What is claimed is:

1. (canceled)

2. The method according to claim 12, wherein the configuration data are retrieved from the first device into the second device.

3. The method according to claim 12, wherein the first device is a computer and the second device is a portable device, wherein the a portable device is connected to a computer for data transmission therebetween.

4. (canceled)

5. (canceled)

6. The apparatus according to claim 14, comprising a receiver/transmitter for performing mobile communication.

7. The apparatus according to claim 14, wherein the apparatus is a portable computer or a personal digital assistant device.

8. (canceled)

9. The system according to claim 15, wherein the first device is one of the following: a mobile phone, a portable computer, or a personal digital assistant device, and the second device is a computer.

10. A computer program product in which an adapter program is stored in a computer readable medium, said adapter program realizing the following when executed by a data processor:
adapting said data processor to a second device and transmitting data therebetween, and
receiving configuration data from said second device to implement the adaptation.

11. A computer program product in which a computer program is stored in a computer readable medium, said computer program realizing the following when executed by a data processor:
adapting said data processor to another device and transmitting data therebetween, and
storing configuration data relating to the adaptation of said data processor as well as instructions for transmitting said configuration data to said another device.

12. A method comprising:
sharing data between a first device and a second device,
adapting the first device to the second device for sharing data between said devices,
executing an adapter program in the second device so as to adapt the first device to the second device on the basis of configuration data of the first device wherein the configuration data of the first device are arranged in said first device.

13. An apparatus comprising:
a controller and an associated input/output module for setting up a data transmission connection to a second device,
the controller arranged to know setting data of the second device for adapting said second device, said controller arranged to retrieve configuration data of the second device from said second device and to implement the adapting of the second device based upon the retrieved configuration data.

14. An apparatus comprising:
a controller and an associated input/output module for setting up a data transmission connection to a second device, the second device configured to adapt the apparatus to said second device, as a result of which adaptation of the apparatus is adapted to share data with said second device,
wherein the apparatus is arranged to store such configuration data which are related to said adaptation, said apparatus being arranged to transmit configuration data via the data transmission connection to the second device, to implement the adaptation.

15. A system comprising:
a first device,
a second device,
the first device and second device each configured for setting up a data transmission connection therebetween,
wherein the second device is further configured for adapting said first device, as a result of which adaptation the system is arranged to share data between said first and second devices,
wherein said second device is arranged to store configuration data relating to the adaptation, the second device being arranged to retrieve said configuration data from the first device via the data transmission connection so as to implement the adaptation.

16. An apparatus comprising:
means for setting up a data transmission connection to a second device,
means for knowing setting data of the second device for adapting said second device for retrieving configuration data of the second device from said second device and for implementing the adapting of the second device based upon the retrieved configuration data.

17. An apparatus comprising:
means for setting up a data transmission connection to a second device, the second device means for adapting the apparatus to said second device, as a result of which adaptation of the apparatus is adapted to share data with said second device,
the apparatus having means for storing such configuration data which are related to said adaptation, said apparatus having means for transmitting configuration data via the data transmission connection to the second device, to implement the adaptation.
